(19) United States
(12) Patent Application Publication
(10) Pub. No.: US 2007/0127090 A1
(43) Pub. Date: Jun. 7, 2007

(54) Image forming apparatus, method for controlling image forming apparatus, device for detecting sheet member, and feeding device

(76) Inventor: Manabu Nonaka, Kanagawa (JP)

Correspondence Address: COOPER & DUNHAM, LLP, 1185 AVENUE OF THE AMERICAS, NEW YORK, NY, 10036, US

(21) Appl. No.: 11/605,006

(22) Filed: Nov. 28, 2006

(30) Foreign Application Priority Data
Dec. 1, 2005 (JP) 2005-348346

(51) Int. Cl. H04N 1/04

(52) U.S. Cl. 358/498

(57) ABSTRACT

A disclosed image forming apparatus includes: a recording head for discharging droplets to a record medium and forming an image; a feeding unit feeding the record medium to an image forming position where the recording head forms the image; and a control unit performing control based on a change of a thickness of the record medium in a carrying direction.

### BACKGROUND OF THE INVENTION

1. Field of the Invention

The present invention relates to an image forming apparatus, a method for controlling an image forming apparatus, a device for detecting a sheet member, and a feeding device.

2. Description of the Related Art

Ink-jet recording apparatuses are known as image forming apparatuses such as printers, facsimile devices, copying devices, printer/facsimile/copier multifunction machines, and the like in which a recording head (image forming unit) made of a liquid discharging head for discharging droplets of a recording liquid is used, for example, and image forming (recording, printing, photo printing, and character printing are used as synonyms thereof) is performed by attaching the droplets of the recording liquid (hereafter also referred to as an ink liquid) to paper while carrying the paper (materials are not limited to paper but record media, recording media, transfer materials, recording paper are used as synonyms thereof).

As disclosed in Patent Document 1, a paper feed controlling device in an image forming apparatus is known. The disclosed paper feed controlling device includes a detection unit detecting a position of a flap of an envelope relative to a face of the envelope and a vertical position thereof relative to a body of the envelope when the envelope is carried, a direction judgment unit judging a front and a back of the envelope and a direction thereof based on a detection signal from the detection unit, and a recording judgment unit judging whether to perform recording based on the front and the back and the direction of the envelope judged by the direction judgment unit in order to detect erroneous setting upon feeding recording paper such as envelopes and the like having the front and the back and a feeding direction and to obtain appropriate printing without resetting the recording paper when the front and the back are appropriately set even if the direction thereof is inappropriate.

Patent Document 1: Japanese Patent No. 3067279

In the apparatus disclosed in Patent Document 1, plural thickness detection units are disposed in a direction orthogonal to a paper carrying direction and the front and the back of the envelope are detected from a detection result of the thickness detection units.

Further, Patent Document 2 discloses a printer provided with a mechanism for automatically adjusting a clearance between paper and a printing head in accordance with a thickness of the paper. In the disclosed printer, a pair of paper detection sensors is disposed on a paper passage portion, envelopes are detected in accordance with a combination of presence and absence of a paper detection performed by the paper detection sensors, and a paper thickness is automatically adjusted upon printing on the envelope such that the clearance between the printing head and the envelope is appropriately secured so as to allow the passage of the envelope through the clearance with the printing head.

Patent Document 2: Japanese Laid-Open Patent Application No. 5-155098

In the apparatus disclosed in Patent Document 2, plural paper detection sensors are disposed in the direction orthogonal to the paper carrying direction and one paper detection sensor is disposed on a position such that paper is not detected when an envelope is set with its flap open, thereby detecting whether a certain material set in the apparatus is an envelope or not.

Further, Patent Document 3 discloses an image forming apparatus including a mode selection unit selecting modes for transferred materials with different thickness such as an envelope mode and the like, an on-off switching unit switching on and off a detach charger, and an electric charge increasing unit switching off the on-off switching unit in accordance with a mode selection signal and increasing an amount of electric charge applied to a transferred material from a transfer charger.

Patent Document 3: Japanese Laid-Open Patent Application No. 8-272232

Examples of a printing medium (record medium) used in image forming apparatuses for forming images by discharging droplets of a recording liquid as mentioned above include various types of forms such as cut sheets having no change of thickness, envelopes having a overlapped portion, label-attached envelopes, and the like.

As disclosed in the above-mentioned Patent Documents 1 and 2, in the structure where the plural paper detection sensors and the thickness detection sensor are disposed in the direction orthogonal to the paper carrying direction, there is a problem in that various types of inconvenience are generated, since it is impossible to determine whether a medium is an envelope or not when an envelope is fed with its flap open or with its flap closed or it is impossible to determine whether the flap of the envelope is open or closed in a case of an envelope.

Further, upon performing printing on a print medium such as an envelope having a portion of different thickness, the following problems are generated, for example.

As disclosed in Patent Document 2, unless a gap between the recording head and the printing medium is adjusted, a nozzle face of the head is scraped by the printing medium such as an envelope and images may become less uniform. Further, when the gap is adjusted, a distance between the nozzle face of the recording head and the envelope is changed, so that impact points of the discharged droplets are displaced and image quality may be degraded.

Further, when a feeding path of the envelope has a curved surface such as a roller, curl is formed on the envelope and a tip of the envelope is lifted from a carrying path, so that the tip of the envelope interferes with the nozzle face of the recording head. In accordance with this, feeding may become unstable or images may become less uniform. Moreover, when the envelope after printing is warped for carrying, winkles are likely to be generated.

In addition, when the envelope is fed while the flap id not adhered, winkles and displacement may be generated in the flap portion. Thus, the envelope is preferably fed with its flap open. However, when it is impossible to judge whether the flap is open or not, erroneous operations may be generated when changing carrying control or printing control. Further, when the envelope is fed with its flap open, a size of the envelope with its flap open becomes larger than that of a body of the envelope and a carrying error may be generated. In addition, when the envelope is fed with its flap open, printing may be performed on the flap.

### SUMMARY OF THE INVENTION

It is a general object of the present invention to provide an improved and useful image forming apparatus, control method thereof, device for detecting a sheet member which can be applied to the image forming apparatus, and feeding device including the detection device, in which the above-mentioned problems are eliminated.

A more specific object of the present invention is to provide an improved and useful image forming apparatus that can perform stable carrying of record media such as envelopes having a varying thickness or a varying size, control method thereof, device for detecting a sheet member which can be applied to the image forming apparatus, and feeding device including the detection device.

In order to achieve the above-mentioned objects, an image forming apparatus according to the present invention includes a control unit performing control based on a change of a thickness of a record medium in a carrying direction.

The image forming apparatus may include a thickness detection unit detecting a thickness of the record medium fed by a feeding unit and a thickness change detection unit detecting a change of the thickness of the record medium in the carrying direction based on a detection result of the thickness detection unit. The image forming apparatus may include a type detection unit detecting a type of the record medium based on the change of the thickness of the record medium in the carrying direction. In this case, preferably, a type of the record medium is detected based on a single change of thickness. Further, the type detection unit preferably detects whether the type of the record medium is an envelope or not.

When the type of the record medium is an envelope, preferably, an output indicating need for adjustment is made so as to adjust a distance between the recording head and the record medium or the distance between the recording head and the record medium is adjusted. Further, a printing mode is preferably changed when the type of the record medium is an envelope.

Preferably, carrying of the record medium is stopped for a required time before the recording medium is fed to an image forming position when the type of the record medium is an envelope. In this case, preferably, a period of time when the carrying of the recording medium is stopped is capable of change.

Preferably, a printing start position relative to the record medium is changed when the type of the record medium is an envelope. In this case, a tip of the record medium is preferably carried to a position of a regulation member for regulating a lift of the record medium.

Preferably, a carrying path for ejecting the record medium is set to be a paper ejection path determined in advance when the type of the record medium is an envelope. In this case, the paper ejection path for ejecting a record medium is preferably set to be a horizontal paper ejection path for ejecting a record medium in a substantially horizontal manner.

Preferably, a status of a flap of the envelope is detected when the type of the record medium is an envelope. In this case, preferably, control for detecting a carrying error of the record medium is changed when the flap of the envelope is open and printing on the flap is regulated when the flap of the envelope is open.

Preferably, the thickness detection unit detecting the thickness of the record medium is disposed upstream relative to the image forming position and in a vicinity of a roller for carrying the record medium. In this case, the roller is preferably a register roller.

In a method for controlling an image forming apparatus according to the present invention, control for an envelope is performed when a type of a record medium is determined as an envelope based on a change of a thickness of the record medium in a carrying direction.

In this case, when the type of the record medium is an envelope, preferably, an output indicating need for adjustment is made so as to adjust a distance between a recording head for discharging droplets and the envelope or control for adjusting the distance between the recording head for discharging the droplets and the envelope is performed. Further, a printing mode is preferably changed when the type of the record medium is an envelope.

Preferably, carrying of the envelope is stopped for a required time before the envelope is fed to an image forming position when the type of the record medium is an envelope. In particular, a period of time when the carrying of the envelope is stopped is preferably capable of change.

Preferably, a printing start position is changed when the type of the record medium is an envelope. In particular, a tip of the envelope is preferably carried to a position of a regulation member for regulating a lift of paper.

Preferably, the envelope is ejected through a carrying path determined in advance when the type of the record medium is an envelope. In particular, the envelope is preferably ejected through a horizontal paper ejection path for ejecting an envelope in a substantially horizontal manner.

Preferably, a flap of the envelope is detected to be open when the type of the record medium is an envelope. In particular, control for detecting a carrying error of paper is preferably changed when the flap of the envelope is detected to be open and printing on the flap is preferably regulated when the flap of the envelope is detected to be open.

A sheet member detection device for detecting a change of a thickness of a sheet member according to the present invention comprises a thickness detection unit detecting a thickness of a sheet member to be carried, wherein a change of the thickness of the sheet member in a carrying direction is detected based on a detection result of the thickness detection unit.

Preferably, a type of the sheet member is detected based on the change of the thickness of the sheet member in the carrying direction. In this case, the type of the sheet member is preferably detected based on a single change of thickness. Further, whether the type of the sheet member is an envelope or not is preferably detected.

A feeding device for feeding a sheet member according to the present invention comprises the detection device according to the present invention.

Preferably, the thickness detection unit is disposed in a vicinity of a roller for carrying the sheet member. In this case, the roller is preferably a register roller.

The image forming apparatus according to the present invention includes the control unit performing control based on the change of the thickness of the record medium in the carrying direction. Thus, it is possible to perform stable carrying and image forming for a record medium such as an envelope that may change in thickness or size thereof.

According to the method for controlling an image forming apparatus of the present invention, control for an envelope is performed when the type of the record medium is determined as an envelope based on the change of the thickness of the record medium in the carrying direction. Thus, it is possible to perform stable carrying and image forming for an envelope.

According to the sheet member detection device of the present invention, the change of the thickness of the sheet member in the carrying direction is detected based on a detection result of the thickness detection unit. Thus, it is possible to readily detect whether a sheet member is an envelope or not by applying the sheet member detection device to the image forming apparatus.

The feeding device according to the present invention includes the sheet member detection device according to the present invention. Thus, it is possible to obtain a feeding device readily capable of detecting whether a sheet member is an envelope or not by applying the feeding device to the image forming apparatus.

Other objects, features and advantage of the present invention will become more apparent from the following detailed description when read in conjunction with the accompanying drawings.

### BRIEF DESCRIPTION OF THE DRAWINGS

FIG. 1 is a schematic configuration diagram showing an entire structure of an image forming apparatus according to the present invention;

FIG. 2 is a plan view showing an image forming unit and a sub-scanning carrying unit in the apparatus;

FIG. 3 is a side elevational view with a fragmentary perspective view showing the apparatus;

FIG. 4 is a schematic diagram showing a paper carrying path for a carrying belt;

FIG. 5 is a perspective view showing an example of a gap adjustment mechanism;

FIG. 6 is a block diagram illustrating an outline of a control unit of the apparatus;

FIG. 7 is a diagram illustrating detection of a change of a thickness of a sheet member;

FIG. 8 is another diagram illustrating detection of a change of a thickness of a sheet member;

FIG. 9 is a diagram illustrating detection of a change of a thickness of an envelope with its flap closed;

FIG. 10 is a diagram illustrating detection of a change of a thickness of an envelope with its flap open;

FIG. 11 is a flowchart illustrating processing for detecting a type of a sheet material;

FIG. 12 is a flowchart illustrating printing processing for an envelope;

FIG. 13 is a diagram illustrating processing for temporarily stopping before a printing unit; and

FIG. 14 is a diagram illustrating processing for changing a printing start position.

### DETAILED DESCRIPTION OF THE PREFERRED EMBODIMENTS

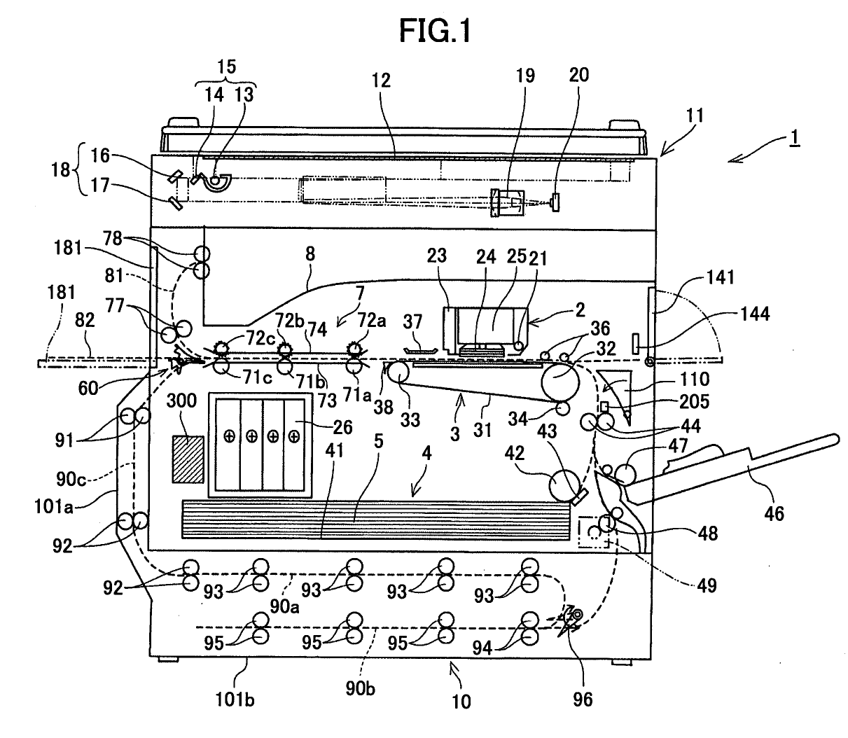

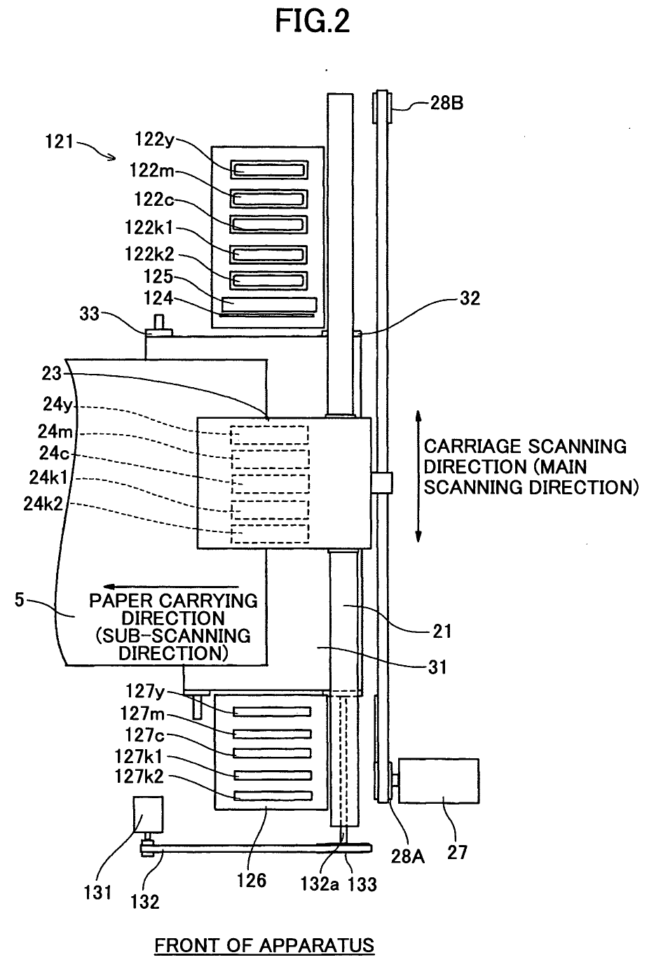

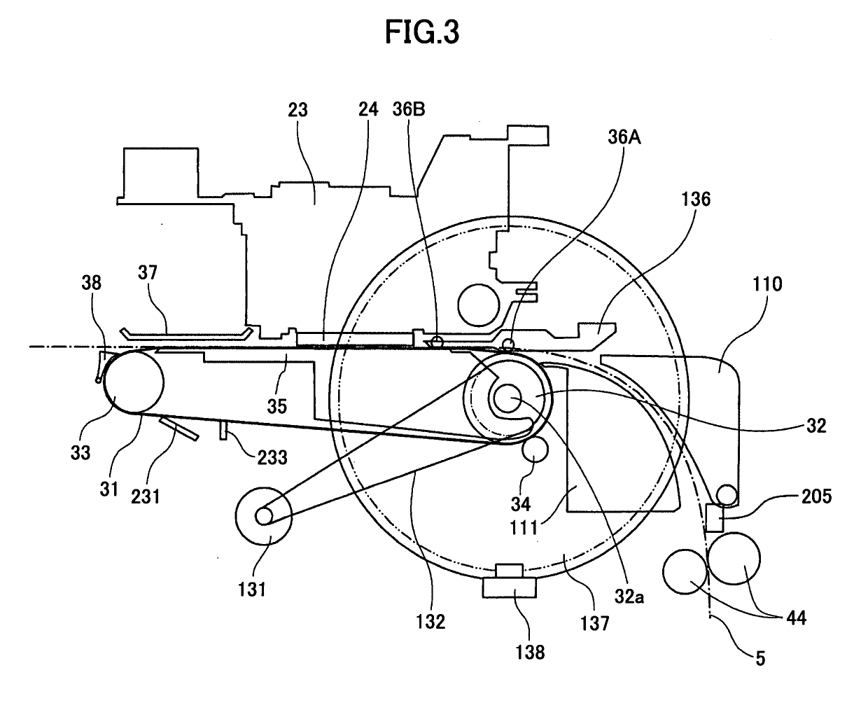

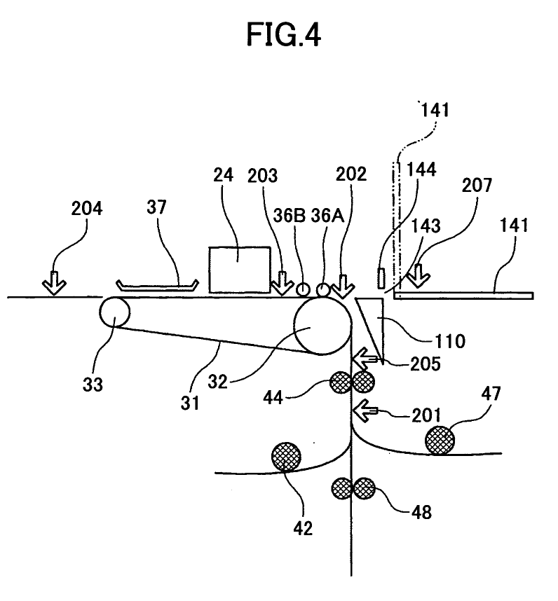

In the following, embodiments of the present invention will be described with reference to the accompanying drawings. An outline of an example of an image forming apparatus according to the present invention including a paper carrying device according to present invention is described with reference to FIGS. 1 to 4. FIG. 1 is a schematic configuration diagram showing an entire structure of an image forming apparatus. FIG. 2 is a plan view showing an image forming unit and a sub-scanning carrying unit in the apparatus. FIG. 3 is a side elevational view with a fragmentary perspective view showing the apparatus. FIG. 4 is a schematic diagram showing a paper carrying path for a carrying belt.

The image forming apparatus includes an apparatus body 1 and an image forming unit 2 forming an image while carrying paper and a sub-scanning carrying unit 3 carrying paper in the inside of the apparatus body 1 (inside of an enclosure). From a paper feed unit 4 including a paper feed cassette disposed on a bottom of the apparatus body 1, paper 5 is fed by one sheet. While the sub-scanning-carrying unit 3 carries the paper 5 at a position facing the image forming unit 2, the image forming unit 2 forms (records) a required image by discharging droplets to the paper 5. Thereafter, in a case of simplex printing, the paper 5 is ejected on a paper ejection tray 8 formed on a top face of the apparatus body 1 through an ejection paper carrying unit 7. In a case of duplex printing, the paper 5 is fed from a course of the ejection paper carrying unit 7 into a duplex unit 10 disposed on the bottom of the apparatus body 1. Then, switchback carrying is performed and the paper 5 is fed into the sub-scanning carrying unit 3 again and an image is formed, so that both sides of the paper 5 have images. Thereafter, the paper 5 is ejected on the paper ejection tray 8.

Further, the image forming apparatus includes an image reading unit (scanner unit) 11 above the paper ejection tray 8 in an upper portion of the apparatus body 1, the image reading unit 11 reading an image as an input system for image data (printing data) formed in the image forming unit 2. In the image reading unit 11, a first scanning optical system 15 including an illumination light source 13 and a mirror 14 and a second scanning optical system 18 including mirrors 16 and 17 are moved so as to read an image of a manuscript placed on a contact glass 12, and a scanned manuscript image is read by an image reading element 20 as image signals, the image reading element 20 being disposed to the rear of the a lens 19. The read image signals are digitized and subjected to image processing, and then it is possible to print image-processed printing data.

In addition, the image forming apparatus is capable of receiving printing data and the like including image data from hosts such as an image processing apparatus, namely, an external personal computer and the like, an image reading apparatus, namely, an image scanner and the like, an imaging apparatus, namely, a digital camera and the like. The image forming apparatus receives such printing data as an input system for image data (printing data) formed in the image forming unit 2 via cables or a network and is capable of processing the received printing data so as to perform printing.

In this case, as shown in FIG. 2, the image forming unit 2 of the image forming apparatus holds a carriage 23 using a guide rod 21 and a guide rail (not shown in the drawings) such that the carriage 23 is movably cantilevered in a main scanning direction. A main scanning motor 27 moves the carriage 23 and scanning is performed via a timing belt 29 installed between a driving pulley 28A and a driven pulley 28B.

A recording head 24 made of droplet discharge heads for discharging relevant colors is mounted on the carriage 23. The recording head 24 is of a shuttle-type head in which the carriage 23 is moved in the main scanning direction and the paper 5 is fed in the paper carrying direction (sub-scanning direction) by the sub-scanning carrying unit 3 while droplets are discharged from the recording head 24 so as to perform image forming. In addition the recording head 24 may be of a line-type head.

The recording head 24 includes two droplet discharge heads 24k1 and 24k2 each discharging black (Bk) ink and three droplet discharge heads 24c, 24m, and 24y each discharging cyan (C) ink, magenta (M) ink, or yellow (Y) ink, totaling to five droplet discharge heads (hereafter referred to as the recording head 24 unless a specific color is described). Each color is supplied from sub-tanks 25 for relevant colors mounted on the carriage 23.

On the other hand, as shown in FIG. 1, ink cartridges 26 which are recording liquid cartridges for each color in which black (Bk) ink, cyan (C) ink, magenta (M) ink, and yellow (Y) ink are contained are detachably attached to a cartridge installation unit from the front of the apparatus body 1. Ink is supplied from each of the ink cartridges 26 to each of the sub-tanks 25. In addition, black ink is supplied from one of the ink cartridges 26 to two sub-tanks 25.

The recording head 24 may be of what is called a piezo-type head in which a piezoelectric element is used as a pressure generation unit (actuator unit) pressurizing ink in an ink channel (pressure generation chamber) in order to deform a diaphragm forming a wall of the ink channel and change an internal volume of the ink channel, so that ink droplets are discharged. Further, the recording head 24 may be of what is called a thermal-type head in which a heat element is used in order to heat the ink in the ink channel and generate bubbles, so that the ink droplets are discharged from pressure resulting from the generation of bubbles. In addition, the recording head 24 may be of what is called a static electrostatic-type head in which the diaphragm forming the wall of the ink channel and an electrode are disposed in an opposing manner and the diaphragm is deformed from static electricity generated between the diaphragm and the electrode, so that the internal volume of the ink channel is changed and the ink droplets are discharged, for example.

Moreover, in a non-printing area on one side of the scanning direction of the carriage 23, as shown in FIG. 2, there is disposed a maintenance/recovery device 121 for maintaining and recovering a status of nozzles of the recording head 24. The maintenance/recovery device 121 includes five moisture retention caps 122k2, 122k1, 122c, 122m, and 122y (referred to as a moisture retention cap 122 unless a specific color is described) for capping each nozzle face of the five recording heads 24, a suction cap 123, a wiper blade 124 for wiping the nozzle faces of the recording head 24, an empty discharge receiving member 125 for performing empty discharge, namely, discharge of droplets which does not contribute to recording (image forming), and the like.

Further, in a non-printing area on the other side of the scanning direction of the carriage 23, as shown in FIG. 2, there is disposed an empty discharge receiving member 126 for performing empty discharge, namely, discharge of droplets from the five recording heads 24 which does not contribute to recording (image forming). In the empty discharge receiving member 126, there are formed five openings 127k2, 127k1, 127c, 127m, and 127y (referred to as an opening 127 unless a specific color is described) for the recording head 24.

The sub-scanning carrying unit 3 includes, as shown in FIG. 3, a carrying belt 31 of an endless form for changing a carrying direction substantially by 90 degrees and carrying the paper 5 fed from below in an opposing manner to the image forming unit 2, the carrying belt 31 being installed between a carrying roller 32 as a driving roller and a driven roller 33 as a tension roller. The sub-scanning carrying unit 3 also includes an electrification roller 34 as an electrification unit to which a high voltage, which is an alternating voltage, is applied from a high voltage power source so as to electrify a surface of the carrying belt 31, a guide member 35 for guiding the carrying belt 31 in a field facing the image forming unit 2, a pressure roller 36A rotatably held by a hold member 136, the pressure roller 36A pressing the paper 5 to the carrying belt 31 at a position facing the carrying roller 32, a tip pressure roller 36B for pressing the paper 5 to the carrying belt 31 before the recording head 24, a guide plate 37 (guide plate for upper regulation) for holding a top face of the paper 5 in which an image is formed by the image forming unit 2, and a separate claw 38 for separating the image-formed paper 5 from the carrying belt 31.

The carrying belt 31 of the sub-scanning carrying unit 3 is configured to be rotated in the paper carrying direction (sub-scanning direction) in FIG. 2 when the carrying roller 32 is rotated by a sub-scanning motor employing a DC brushless motor 131 via a timing belt 132 and a timing roller 133. The carrying belt 31 has a double-layer structure made of a surface layer used as a paper attraction face formed with a pure resin material such as an ETFE pure material in which resistance is not controlled and an underlayer (middle resistive layer, earth layer) formed with the same material as in the surface layer and resistance is controlled using carbon. However, the carrying belt 31 is not limited to this but may have a single-layer structure or more than the double-layer structure.

In addition, from an upstream of the movement direction of the carrying belt 31, between the driven roller 33 and the electrification roller 34, there are disposed a Myler 231 made of a PET film as an abutment member in abutment with the surface of the carrying belt 31, the Myler 231 removing paper dust attracted on the surface of the carrying belt 31 as a cleaning unit, and a discharge brush 233 for removing an electric charge on the surface of the carrying belt 31.

Further, a codewheel 137 with a high resolution is installed on a shaft 32a of the carrying roller 32 and an encoder sensor 138 made of a transmission photosensor for detecting slits formed on the codewheel 137 is disposed. The codewheel 137 and the encoder sensor 138 constitute a rotary encoder.

The paper feed unit 4 can be inserted and detached from a front side of the apparatus body 1. The paper feed unit 4 includes a paper feed cassette 41 for loading and storing multiple sheets of paper 5, a paper feed roller 42 and a friction pad 43 for separating and sending the paper 5 in the paper feed cassette 41 by one sheet, and (a pair of) register rollers 44 for registering the fed paper 5. At a downstream of the paper carrying direction in the vicinity of the register rollers 44, there is disposed a thickness detection sensor 205 for detecting a thickness of the paper 5 to be carried (fed).

The paper feed unit 4 further includes a multi manual feed tray 46 for loading and storing multiple sheets of paper 5, a manual feed roller 47 for separating and feeding the paper 5 from the multi manual feed tray 46 by one sheet, and a longitudinal carrying roller 48 for carrying the paper 5 fed from a paper feed cassette optionally installed in a lower portion of the apparatus body 1 or from the duplex unit 10 described later. Members for feeding the paper 5 into the sub-scanning carrying unit 3, such as the paper feed roller 42, the register rollers 44, the manual feed roller 47, the longitudinal carrying roller 48, and the like are rotated and driven by a paper feed motor (driving unit) 49 made of an HB-type stepping motor via an electromagnetic clutch not shown in the drawings.

The ejection paper carrying unit 7 includes three carrying rollers 71a, 71b, and 71c (referred to as a carrying roller 71 unless a specific roller is described) for carrying the paper 5 separated by the separate claw 38 in the sub-scanning carrying unit 3 and runners 72a, 72b, and 72c (referred to as a runner 72 unless a specific runner is described) facing the carrying rollers 71, a lower guide unit 73 and an upper guide unit 74 guiding the paper 5 carried between the carrying rollers 71 and the runners 72, and a pair of reverse rollers 77 and a pair of reverse paper ejection rollers 78 for turning over the paper 5 through a reverse paper ejection path 81 as a first carrying path, the paper 5 being fed from a space between the lower guide unit 73 and the upper guide unit 74, and sending the paper 5 facedown to the paper ejection tray 8. A carrying path between the lower guide unit 73 and the upper guide unit 74 in which the paper 5 is carried is referred to as a carrying path 70.

At an exit of the carrying path 70, there is disposed a brunch mechanism 60 for switching the carrying path to the first paper ejection path 81 for performing a reverse paper ejection to the paper ejection tray 8, a second paper ejection path 82 for performing paper ejection to a straight paper ejection tray 181 described later, and to the duplex unit 10.

The duplex unit 10 integrally includes a vertical carrying unit 101a constituting a vertical duplex carrying path 90c for receiving the paper 5 fed from a side face of the apparatus body 1 and carrying the paper 5 downwards and a horizontal carrying unit 101b constituting a horizontal intake carrying path 90a and a switchback carrying path 90b, the horizontal intake carrying path 90a carrying the paper 5 in the horizontal direction following the vertical duplex carrying path 90c.

The vertical duplex carrying path 90c includes a pair of duplex entrance rollers 91 for carrying the fed paper 5 downward and a pair of carrying rollers 92 for feeding the paper 5 into the horizontal intake carrying path 90a. The horizontal intake carrying path 90a includes five pairs of duplex carrying rollers 93. The switchback carrying path 90b includes a pair of duplex exit rollers 94 and three pairs of duplex carrying rollers 95, the duplex exit rollers 94 being made of reverse rollers for turning over and refeeding the paper 5 fed from the horizontal intake carrying path 90a.

Further, there is disposed a branch plate 96 in a swingable manner for switching a carrying path of the paper 5 from the horizontal intake carrying path 90a to the switchback carrying path 90b and the carrying path for refeeding from the switchback carrying path 90b to the pair of carrying rollers 48. The branch plate 96 is capable of swinging between a switchback position shown in solid lines and a refeeding position shown in broken lines in FIG. 1.

The paper 5 fed from the duplex unit 10 is fed into the carrying rollers 48 and then fed into the register rollers 44.

As shown in FIGS. 1 and 3, there is disposed an opening/closing guide plate 110 facing a guide unit 111 in a swingable manner for forming a loop (warping) in the paper 5 so as to prevent back tension and the like relative to the paper 5 between the carrying roller 32 and the register rollers 44 of the sub-scanning carrying unit 3 and the register rollers 44 upon carrying the paper 5 on the register rollers 44, the paper 5 being fed from the paper feed cassette 41 of the paper feed unit 4, the multi manual feed tray 46, and the duplex unit 10. The opening/closing guide plate 110 is swung by a solenoid (not shown in the drawings) for the opening/closing guide plate.

When the paper 5 is fed into the sub-scanning carrying unit 3 from the register rollers 44, the opening/closing guide plate 110 swings to a direction of the guide unit 111 from a status shown in the drawings and guides the paper 5. When the paper 5 reaches the sub-scanning carrying unit 3, the opening/closing guide plate 110 returns to the status shown in the drawings by which a loop is formed.

Further, in this image forming apparatus, a manual single feed tray 141 is disposed on one side of the apparatus body 1 in an openable and closable manner (tilted and opened) relative to the apparatus body in order to perform paper feeding by one sheet. When manual single feeding is performed, the manual single feed tray 141 is tilted and opened at a position shown in imaginary lines in the figure. The paper 5 manually fed from the manual single feed tray 141 is guided on a top face of the opening/closing guide plate 110 and it is possible to directly insert the paper 5 between the carrying roller 32 and the pressure roller 36A in the sub-scanning carrying unit 3.

On the other hand, the straight paper ejection tray 181 is disposed on the other side of the apparatus body 1 in an openable and closable manner (tilted and opened) in order to straightly eject the paper 5 faceup. By opening (tilting and opening) the straight paper ejection tray 181, the second paper ejection path 82 for ejecting the paper 5 straightly on the straight paper ejection tray 181 is formed, the paper 5 being fed into the ejection paper carrying unit 7 from the lower guide unit 73 and the upper guide unit 74.

In this manner, for example, when using paper which is difficult to carry in a curved path such as OHP, thick paper, and the like, it is possible to linearly carry the paper 5 to the straight paper ejection tray 181 by performing manual feeding by one sheet from the manual single feed tray 141. In addition, general paper such as plain paper may be fed from the manual single feed tray 141 and linearly ejected on the straight paper ejection tray 181.

Various types of sensors arranged to the image forming unit 2 are described with reference to FIG. 4. A carrying registration sensor 201 is disposed upstream relative to the register rollers 44 and a printing unit entrance sensor 202 is disposed before the carrying roller 32 and the pressure roller 36A so as to detect the paper 5. An image registration sensor 203 for registering an image drawing start position is disposed downstream relative to the tip pressure roller 36B (entrance of the image forming unit 2). A printing unit exit sensor 204 is disposed at an exit of the image forming unit 2 (before the carrying roller 71a). Further, as mentioned above, the thickness detection sensor 205 is disposed downstream in the vicinity of the register rollers 44. And there is disposed a manual feeding paper detecting sensor 207 for detecting presence of the paper 5 set on the manual single feed tray 141.

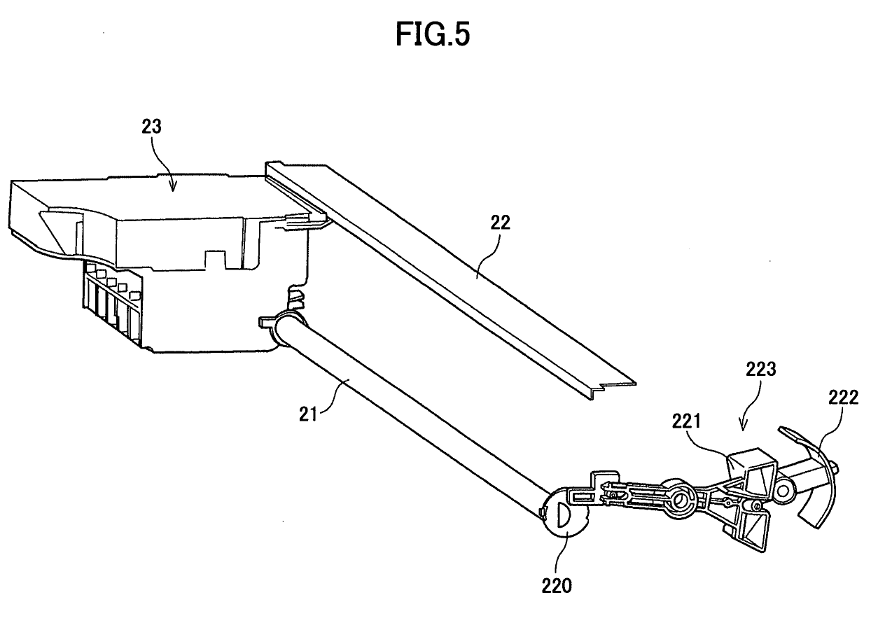

Next, the following describes a mechanism for adjusting a gap between the recording head 24 and the paper 5 on the carrying belt 31 in the image forming apparatus with reference to FIG. 5.

One end of the guide rod 21 to which the carriage 23 is slidably attached is eccentrically held by a holding plate 220. The gap adjustment mechanism includes an adjustment lever 223 made of a first lever unit 221 and a second lever unit 222 for rotating the holding plate 220. In this case, the holding plate 220 is rotatably held by a side plate not shown in the drawings. The first lever unit 221 is swingably held by a side plate not shown in the drawings and the second lever unit 222 is swingably connected to the first lever unit 221 with some play.

Thus, by swinging the second lever unit 222, the first lever unit 221 is swung and the holding plate 220 is rotated. In accordance with the rotation of the holding plate 220, the guide rod 21 is moved upward or downward and the carriage 23 is moved upward or downward, so that a gap between the recording head 24 and the paper 5 on the carrying belt 31 is adjusted.

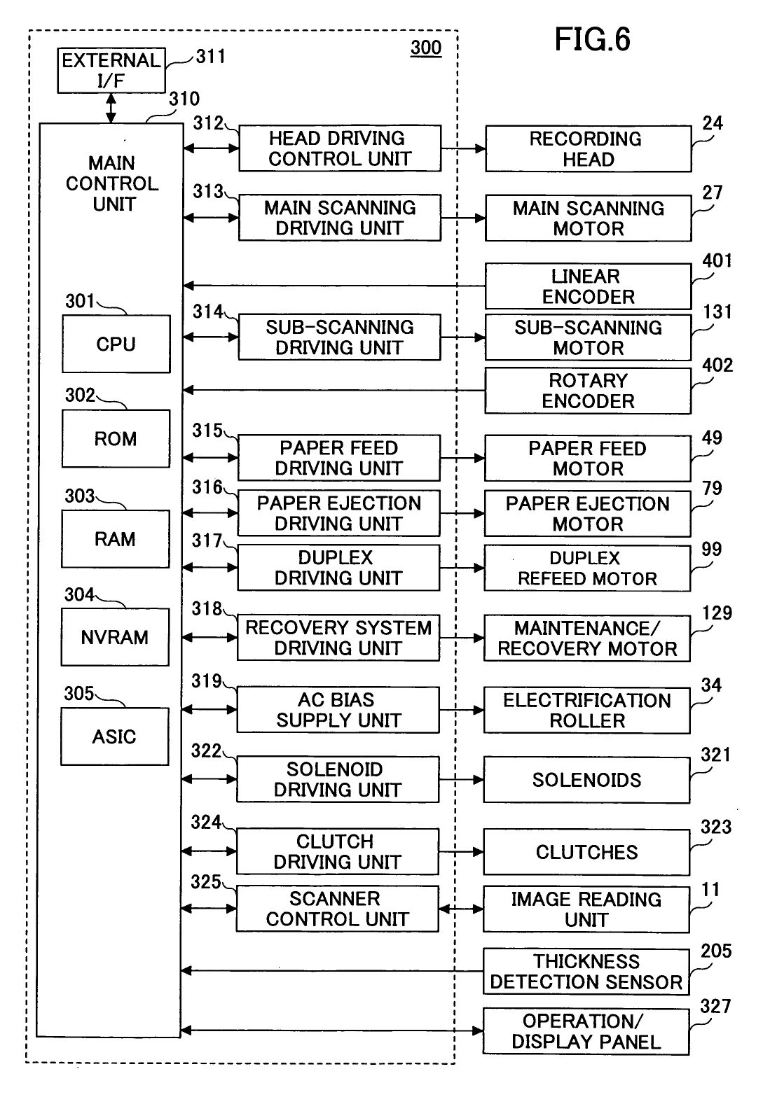

Next, an outline of a control unit of the image forming apparatus is described with reference to a block diagram in FIG. 6.

A control unit 300 is provided with a main control unit 310 for performing entire control on the apparatus and cleaning control on the carrying belt 31 according to the present invention. The main control unit 310 includes a CPU 301, a ROM 302 for storing a program executed by the CPU 301 and other fixed data, a RAM 303 for temporarily storing image data and the like, a non-volatile memory (NVRAM) 304 for holding data while a power supply to the apparatus is cut off, and an ASIC 305 for performing various types of signal processing for image data, image processing for rearrangement and the like, and input/output signal processing for controlling other portions of the apparatus.

Further, the control unit 300 includes an external I/F 311 disposed between a host and the main control unit 310, the external I/F 311 transmitting and receiving data and signals, a head driving control unit 312 having a head driver (disposed on the recording head 24) for controlling the driving of the recording head 24, a main scanning driving unit (motor driver) 313 driving the main scanning motor 27 for moving the carriage 23 so as to perform scanning, a sub-scanning driving unit 314 driving the sub-scanning motor 131, a paper feed driving unit 315 driving the paper feed motor 49, a paper ejection driving unit 316 driving a paper ejection motor 79 for driving each roller of the ejection paper carrying unit 7, a duplex driving unit 317 driving a duplex refeed motor 99 for driving each roller of the duplex unit 10, a recovery system driving unit 318 driving a maintenance/recovery motor 129 for driving the maintenance/recovery device 121, and an AC bias supply unit 319 supplying an AC bias to the electrification roller 34.

The control unit 300 further includes a solenoid driving unit (driver) 322 driving various types of solenoids (SOL) 321, a clutch driving unit 324 driving electromagnetic clutches 323 relating to paper feeding, and a scanner control unit 325 controlling the image reading unit 11.

Moreover, the main control unit 310 inputs detection signals (sensor signals) from various types of sensors described in the above-mentioned thickness detection sensor 205 and in FIG. 4. And the main control unit 310 obtains necessary key inputs and outputs display information with an operation/display unit 327 including various types of keys such as a numeric keypad, a print start key, and the like and various types of indicators installed on the apparatus body 1.

Detection signals of a linear encoder 401 are input to the main control unit 310, the linear encoder 401 being made of a linear scale disposed in the main scanning direction for detecting a movement position, an amount of movement, and a speed of the carriage 23 and a photosensor disposed on the carriage 23. The main control unit 310 moves the carriage 23 by controlling the driving of the main scanning motor 27 via the main scanning driving unit 313 based on the output signals.

In addition, output signals (pulses) from a rotary encoder 402 are input to the main control unit 310, the rotary encoder 402 being constituted using the codewheel 137 and the photosensor (encoder sensor) 138. The main control unit 310 moves the carrying belt 31 via the carrying roller 32 by controlling the driving the sub-scanning motor 131 via the sub-scanning driving unit 314 based on the output signals.

The following describes paper carrying and image forming operations in the image forming apparatus constructed as mentioned above.

When a high voltage of positive and negative polarities in square waves is applied to the electrification roller 34 as an alternating voltage from the AC bias supply unit 319, the electrification roller 34 is in abutment with an insulating layer (surface layer) of the carrying belt 31, so that positive and negative charge are alternately applied to the surface layer of the carrying belt 31 in a belt-like manner in a carrying direction of the carrying belt 31. As a result, the carrying belt 31 is electrified on the surface thereof at predetermined intervals and a non-uniform electric field is generated.

When the paper 5 is fed from the paper feed unit 4, the manual feed tray 46, the duplex unit 10, the manual single feed tray 141, or the like and sent on the carrying belt 31 between the carrying roller 32 and the pressure roller 36A where the non-uniform electric field is generated from the forming of the positive and negative charge, the paper 5 is instantaneously polarized in accordance with a direction of an electric field, attracted to the carrying belt 31 due to electrostatic force, and carried along with the movement of the carrying belt 31.

Then, while the paper 5 is intermittently carried using the carrying belt 31, an image is formed (recorded) on the paper 5 by discharging droplets of a recording liquid from the recording head 24 in accordance with printing data. A tip of the image-formed paper 5 is separated from the carrying belt 31 using the separate claw 38 and the paper 5 is ejected on the paper ejection tray 8 or the straight paper ejection tray 181 as appropriate by the ejection paper carrying unit 7, or the paper 5 is fed to the duplex unit 10 where an image is formed on the other face of the paper 5 and then the paper 5 is ejected.

Next, the following describes detection of a thickness change of a sheet member in the image forming apparatus according to the present invention.

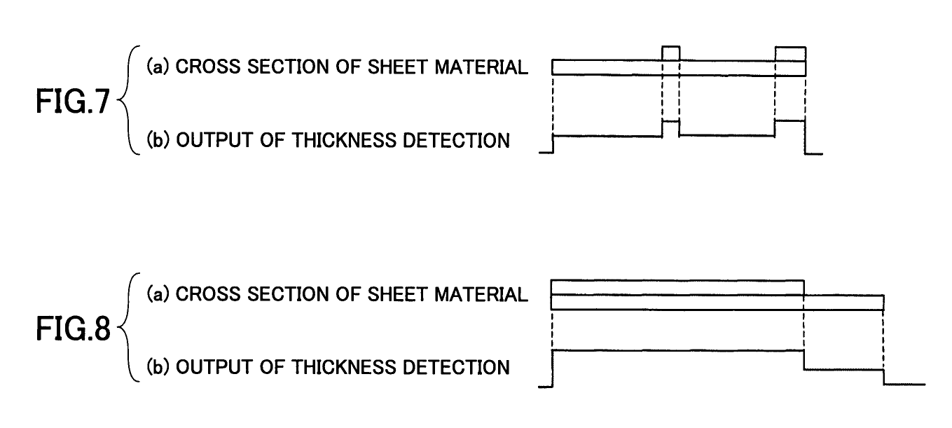

In this case, the thickness change of the sheet member (hereafter also referred to as a sheet material) fed (carried) from the paper feed unit 4 is detected using a transmission photosensor as the thickness detection sensor 205. For example, in a case where the sheet material has a cross-sectional shape (at a position where the sheet material is detected by the thickness detection sensor 205) as shown in FIG. 7-(a), detection outputs dependent on the thickness change of the sheet material are obtained from the thickness detection sensor 205 as shown in FIG. 7-(b). In the same manner, in a case where the sheet material has a cross-sectional shape as shown in FIG. 8-(a), detection outputs dependent on the thickness change of the sheet material are obtained from the thickness detection sensor 205 as shown in FIG. 8-(b). The outputs of the thickness detection sensor 205 are level-reversed, so that an example is described on the assumption that the outputs are lowest when there is no sheet material and the outputs becomes larger in accordance with an increase of the thickness of the sheet material (in the following the same example is used).

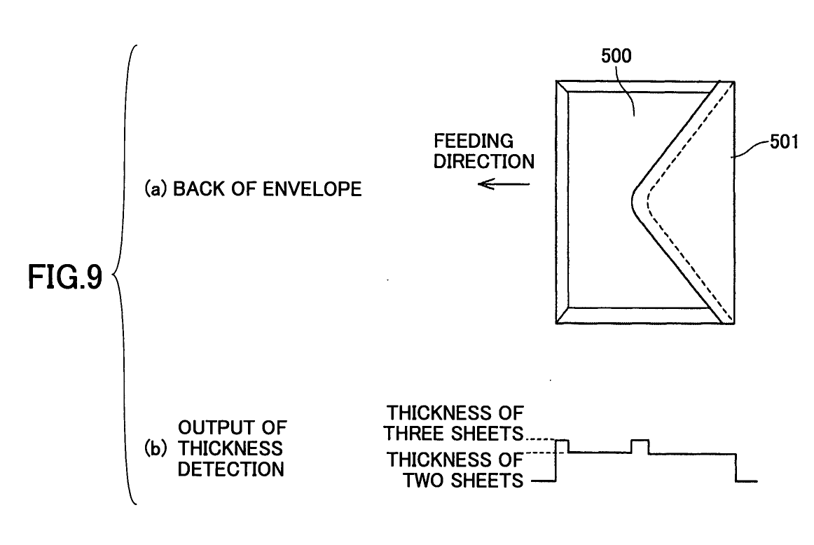

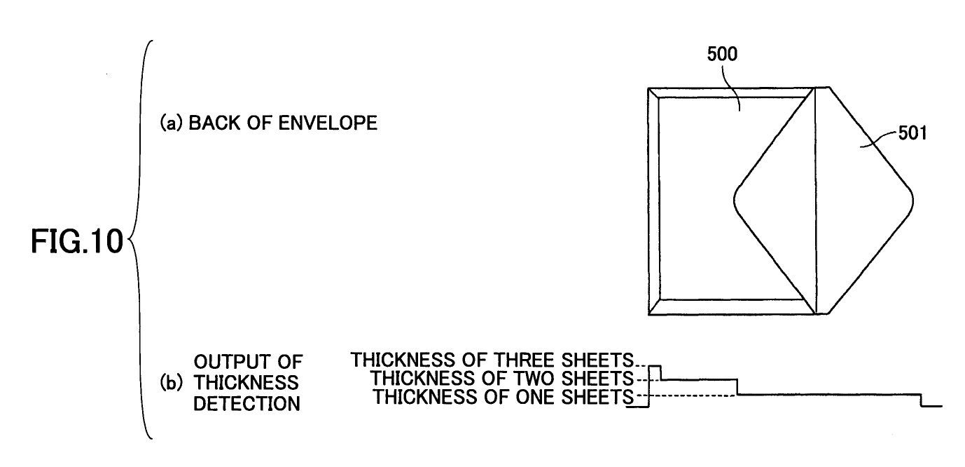

If this is applied to an envelope as shown in FIGS. 9 and 10, when a flap 501 of an envelope 500 is closed as shown in FIG. 9-(a), a detection output dependent on the thickness change of the envelope 500 is obtained as shown in FIG. 9-(b). By contrast, when the flap 501 of the envelope 500 is open as shown in FIG. 10-(a), a detection output dependent on the thickness change of the envelope 500 is obtained as shown in FIG. 10-(b). In this case, the thickness change varies depending on whether the flap 501 is closed or open, so that it is possible to detect whether the flap 501 is closed or open.

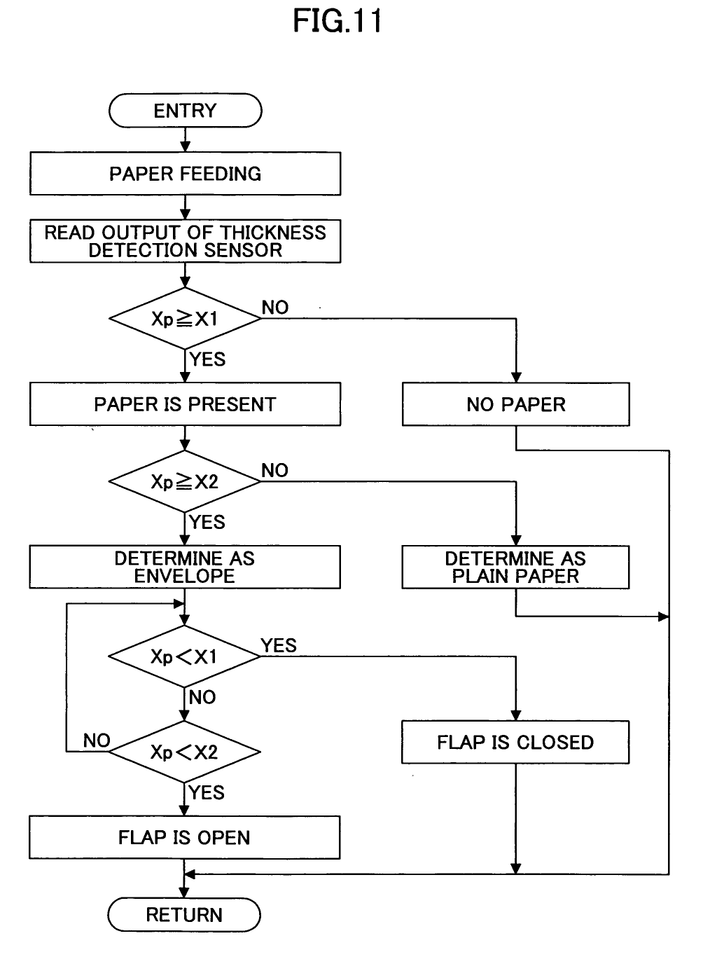

The following describes processing for detecting types of carried sheet materials by the main control unit 310 with reference to FIG. 11.

First, when printing is started, a sheet material is fed from a paper feed unit specified among the paper feed unit 4, the manual feed unit 46, the duplex unit 10, the manual single feed tray 141, and the like.

Then, the main control unit 310 obtains a detection output Xp of the thickness detection sensor 205 and determines whether paper is present by checking whether the thickness detection output Xp is less than a level X1 (Xp<X1) corresponding to a single sheet of a sheet material determined in advance.

In this case, if the thickness detection output Xp is less than the level X1, the main control unit 310 determines that no sheet material is fed from the register rollers 44, namely, there is no paper.

If the thickness detection output Xp is not less than the level X1, the main control unit 310 determines that the sheet material is fed from the register rollers 44, namely, paper is present. And the main control unit 310 determines whether a type of the fed sheet material is an envelope or not by checking whether the thickness detection output Xp is not less than a level X2 (Xp≧X2) corresponding to two sheets of the sheet material determined in advance.

In this case, if the thickness detection output Xp is less than the level X2 (Xp<X2), the main control unit 310 determines that plain paper (a single sheet of paper) is fed.

If the thickness detection output Xp is not less than the level X2 (Xp≧X2), the carried sheet material is considered to have two sheets of paper, so that the main control unit 310 determines that the sheet material is an envelope. When the sheet material is determined to be an envelope in this manner, as will be described later, carriage position warning display, carriage position change operation, printing mode change operation, temporary stop operation before printing, sub-scanning feeding amount increase operation before printing, paper ejection path switching operation, and the like are performed.

Further, the main control unit 310 checks whether the thickness detection output Xp is changed from not less than the level X1 to less than the level X2 (X1≦Xp<X2). If the thickness detection output Xp is unchanged from not less than the level X1 to less than the level X2, namely, if the thickness detection output Xp becomes less than the level X1, the main control unit 310 determines that the flap is closed. If the thickness detection output Xp is changed to not less than the level X1 to less than the level X2, the main control unit 310 determines that the flap is open. In accordance with this, a detection threshold of carrying error is changed or regulation of printing on the flap portion is made, for example, as will be described later.

In this manner, in this image forming apparatus, the thickness of a record medium fed by the feeding unit is detected and the change of the thickness in the carrying direction is detected based on the detection result of the thickness, so that it is possible to determine a type of the record medium (sheet material) and presence/absence of concavity and convexity and perform controlling in accordance with the detection result. Further, by determining (detecting) the type of the sheet material, the necessity to select paper types by a user is eliminated and such an operation can be reduced.

In this case, by detecting (determining) a type of the sheet material on the basis of a single change of the thickness of the carried sheet material, it is possible to reduce the cost of a sensor with a low detection accuracy and control becomes simple. And, by detecting whether the type of the sheet material is an envelope or not, it is possible to perform controlling for the envelope.

In addition, upon detecting the thickness of the fed sheet material, by disposing a thickness detection unit (thickness detection sensor) in the vicinity of a carrying roller, it is possible to detect the sheet material at a position where the behavior of the carried (fed) sheet material is stable (in terms of a distance from the sensor), so that the detection accuracy is improved. In this case, generally, the carrying of the sheet material is temporarily stopped at a time when a tip of the sheet material is brought into contact with a nip portion of the register rollers (when the tip of the sheet material is uniformly brought into contact with the nip portion of the register rollers in the main scanning direction) so as to adjust timing with the image forming unit, so that the register rollers are preferably used as the carrying roller in the vicinity of which the thickness detection sensor is disposed. The detection accuracy is further improved by detecting the thickness when the sheet material is temporarily stopped using the register rollers or by detecting the thickness at a position immediately after a resumption of the carrying following the temporary stop.

Further, by detecting whether the flap of the envelope is open through the detection of the change of the thickness, it is possible to change carrying control and printing control. In other words, when the envelope is fed while the flap is not adhered, the flap portion may be moved or wrinkles may be generated, so that feeding performance is more stabilized when the envelope is fed while the flap is open. In this case, if whether the flap of the envelope is open is not certain, as will be described later, the envelope may be erroneously detected as a carrying error or printing may be performed on the flap. In view of this, by detecting the opening/closing of the flap of the envelope, it is possible to prevent such erroneous detection and erroneous printing.

In the above-mentioned image forming apparatus, the device for detecting the sheet member according to the present invention includes the thickness detection sensor 205 and the main control unit 310. In addition, the feeding device according to the present invention includes the feeding unit such as the paper feed unit 4, the manual feed tray 46, and the like, a unit relating to carrying such as the register rollers 44, the thickness detection sensor 205, and the main control unit 310.

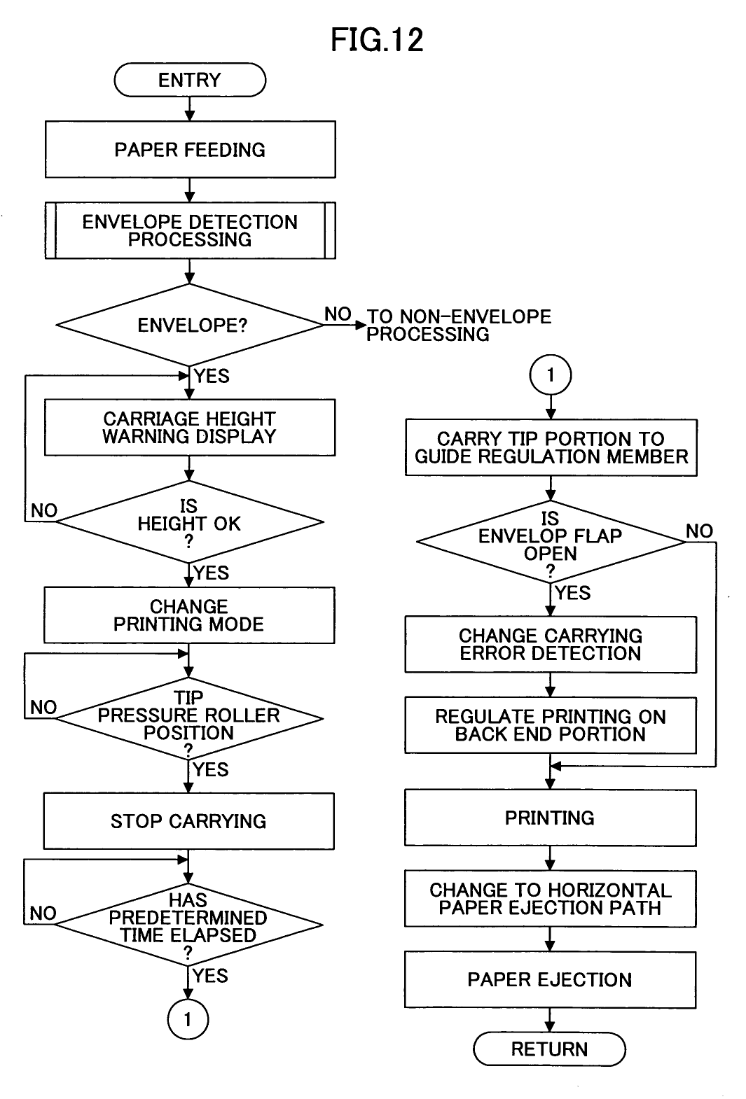

Next, the following describes control performed on the basis of the change of the thickness of the sheet member with reference to FIG. 12.

When printing is started, envelope detection processing is performed on the sheet member fed in accordance with paper feeding as described above so as to detect whether the sheet member is an envelope or not and, in the case of the envelope, whether the flap is open or closed. If the fed sheet member is not an envelope, the process goes to other processing for other sheet material type not shown in the drawings (normal processing).

By contrast, when the fed sheet member is an envelope, information indicating that a gap between the recording head 24 and the envelope must be adjusted is output (warning display for carriage height change) so as to urge the user to adjust a carriage height (gap) by operating the adjustment lever 223.

In other words, the envelope has an overlap structure, so that the gap between the sheet material and the recording head 24 must be increased. Thus, when the user manually performs this gap adjustment operation, by performing the warning display for carriage height as mentioned above, it is possible to prevent the generation of paper jam, for example, resulting from the envelope sent between the recording head 24 and the carrying belt 31 while the gap is not increased.

In this case, by employing a structure including a driving unit such as a motor, a solenoid, and the like and a mechanism for changing the height of the carriage 23 such that the height of the carriage 23 is relatively increased in an automatic manner, when the envelope is detected, the height of the carriage 23 is automatically adjusted. Thus, it is impossible to increase the gap between the sheet material and the recording head without user operation and appliance is improved.

Further, processing for changing a printing mode is performed. The envelope has an overlap structure, so that the gap between the sheet material and the recording head must be increased. However, in this case, accuracy at an impact position of droplets discharged from the recording head 24 is reduced in comparison with a normal head position, so that it is necessary to change to a printing mode suitable for an envelope. In this case, by automatically changing the printing mode, defective images resulting from erroneous setting by the user are reduced.

Then, the main control unit 310 determines whether the tip of the envelope reaches a position of the tip pressure roller 36B (or the pressure roller 36A). When the tip of the envelope reaches the position of the tip pressure roller 36B (or the pressure roller 36A), the main control unit 310 stops the carrying of the envelope and waits until a predetermined time has elapsed.

In other words, if at least one curved carrying path (circumferential surface of the carrying belt 31 that follows a circumferential surface of the carrying roller 32) is provided between the feeding unit and an image forming position (printing unit) made of the recording head 24 as in this image forming apparatus, the envelope to be carried is curved and then carried. The envelope has an overlap structure, so that curl is likely to be formed. In particular, when the envelope is fed from the multi manual feed tray 46 through the manual feed roller 47, the envelope is drawn in a direction opposite to the circumferential surface of the carrying roller 32 through the manual feed roller 47, so that the tip portion is likely to be curled in a direction distancing from the circumferential surface of the carrying roller 32. In this case, when the envelope is attracted using electrostatic attraction as in the carrying belt 31, electrostatic force is not generated at the tip portion and failure of attraction may be generated.

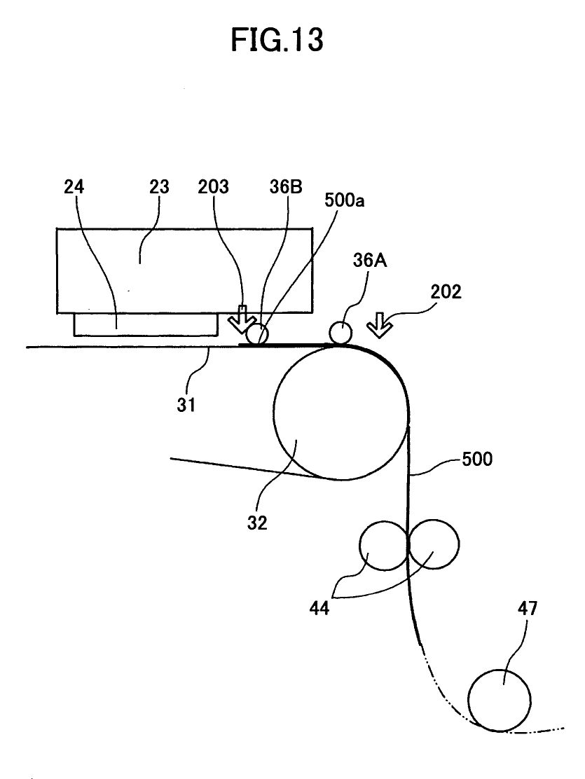

In view of this, as shown in FIG. 13, for example, the main control unit 310 detects that a tip portion 500a of the envelope 500 is carried to a position where the envelope 500 is pressed by the pressure roller 36A. And the curl is corrected by performing carrying control in which the envelope is stopped at this position for a predetermined time, so that carrying performance of the envelope is stabilized in the image forming unit.

In this case, forming of the curl is different depending on types of the envelope, so that by enabling adjustment (manual or automatic) of a length of time for the temporary stop, it is possible to avoid uselessly increased time for temporary stop and eliminate an unnecessary temporary stop. Thus, a printing speed in total is improved (productivity is improved).

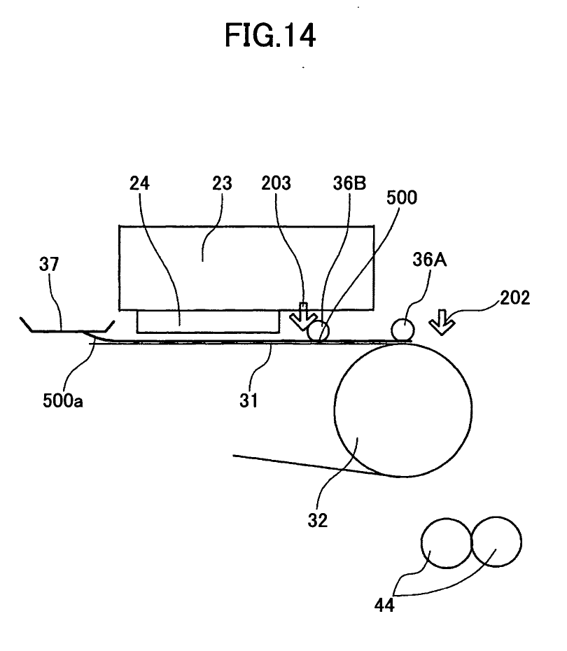

Thereafter, as shown in FIG. 14, the envelope is carried again and the envelope is carried until the tip portion 500a of the envelope 500 is regulated by the upward regulation guide plate 37.

In other words, when a printing medium is an envelope, the printing start position in the sub-scanning direction is moved upstream relative to the carrying direction in comparison with a normal case (the amount of carrying in the sub-scanning direction before printing is increased and the non-printing area in the tip portion is increased). In accordance with this, upon starting printing, it is possible to keep the tip portion of the envelope away from the recording head in the sub-scanning direction and to prevent the influence of curl in the tip portion of the envelope on the printing unit (immediately below the head).

In this case, as mentioned above, the tip portion of the envelope before printing is carried to the position regulated by the member for regulating a lift of the paper to the recording head (although examples of the member include the upward regulation guide plate 37, the member may be constructed using a runner or the like). Thus, it is possible to certainly prevent the influence of curl in the tip portion of the envelope on the printing unit (immediately below the head).

It is possible to perform both the above-mentioned carrying control with the temporary stop before the printing unit and the carrying control with the change of the printing start position. Further, it is possible to omit the carrying control with the change of the printing start position if curl is sufficiently corrected through the temporary stop, or it is possible to carry the tip portion to the member for regulating a lift and perform only the carrying control with the change of the printing start position without performing the carrying control with the temporary stop.

Next, the main control unit 310 determines whether the flap of the envelope is open or closed. If the flap of the envelope is closed, a required printing is performed on the envelope, the paper ejection path is switched to the horizontal paper ejection path 82 by the paper ejection path switching mechanism 60, and the envelope is ejected in the horizontal direction.

In other words, if plural paper ejection paths are provided as paper ejection paths after printing as in this image forming apparatus, in the case of the envelope, the envelope is ejected through an ejection paper carrying path different from those of other paper types. The construction of the envelope is substantially different from those of other sheet materials in that paper is overlapped, so that carrying performance is greatly affected. In view of this, upon ejecting the envelope, by ejecting the envelope through the carrying path different from those of other sheet materials, setting suitable for carrying the envelope is possible and carrying performance is stabilized. In this case, by carrying the envelope through the horizontal paper ejection path after the printing, it is possible to prevent the generation of failure such as a wrinkle that may be generated when the envelope is curved and carried and carrying performance is stabilized.

By contrast, if the flap of the envelope is open, the carrying error detection is changed. In other words, in this image forming apparatus, when a paper detection sensor such as the printing unit entrance sensor 202 (or the printing unit exit sensor 204) detects paper even after sub-scanning carrying is performed for a size of paper to be used, carrying error detection is performed in which the sub-scanning carrying is handled as not normally conducted and determined as a carrying error.

On the other hand, in general, when the user uses an envelope, the user inputs a size of the envelope so that the image forming apparatus recognizes the envelope. However, when the envelope is fed with its flap open, a shape of the flap portion is not input. Thus, although the image forming apparatus carries the envelope as much as a sub-scanning length of the input paper size, the paper detection sensor disposed on the carrying unit detects the sheet material just as much as a length of the flap. As a result, the envelope is detected as having the carrying error.

In view of this, when the flap of the envelope is open, by changing time for detecting paper in which the carrying error is detected (changed to time corresponding to a length twice the length of the envelope in the sub-scanning direction), it is possible to prevent the erroneous detection of the carrying error due to the opened flap of the envelope.

Further, when the flap of the envelope is open, processing for regulating printing on the flap portion of the envelope (processing for regulating printing on a back end portion) is performed. In other words, in general, as mentioned above, when the user uses the envelope, the user inputs the size of the envelope so that the image forming apparatus recognizes the envelope. In addition, when image information exceeding the input paper size is printed, printing of the image information is generally regulated through detection of the back end of the paper from the sensor disposed on the carrying path.

However, if the envelope is fed with its flap open, the shape of the flap portion is not input, so that the image forming apparatus performs printing on the flap when there is image information exceeding the input length of the paper in the sub-scanning direction. In view of this, when the flap of the envelope is open, by regulating printing on the flap, it is possible to prevent the printing on the flap and to perform printing on an appropriate area in the envelope.

In the above-mentioned embodiment, the examples are described as the control performed in accordance with the change of the thickness of the record medium in the carrying direction based on the change of the thickness of the record medium in the carrying direction or as the control performed in accordance with the envelope in which such control includes all of the warning display for carriage height (or the automatic adjustment of carriage height), the printing mode change, the temporary stop processing before the printing unit, the change of the printing start position (the increase of the amount of feeding in the sub-scanning direction before printing), the switching of paper ejection paths, the change of a detection threshold of carrying error, and the regulation of printing on the flap portion. However, this is intended to avoid repetition of description, so that it is not necessary to perform all such control. Thus, by selecting and applying control necessary for a relevant apparatus, it is possible to obtain the above-mentioned effect based on the selection and application.

Further, in the above-mentioned embodiment, although the present invention is applied to a multifunction image forming apparatus as the example, it is possible to apply the present invention to other image forming apparatuses such as printers, facsimile apparatuses, and the like in the same manner. Moreover, it is possible to apply the present invention to image forming apparatuses using a recording liquid other than ink.

The present invention is not limited to the specifically disclosed embodiment, and variations and modifications may be made without departing from the scope of the present invention.

The present application is based on Japanese priority application No. 2005-348346 filed Dec. 1, 2005, the entire contents of which are hereby incorporated herein by reference.

What is claimed is:

1. An image forming apparatus comprising:
a recording head for discharging droplets to a record medium and forming an image;
a feeding unit feeding the record medium to an image forming position where the recording head forms the image; and
a control unit performing control based on a change of a thickness of the record medium in a carrying direction.

2. The image forming apparatus according to claim 1, including:
a thickness detection unit detecting a thickness of the record medium fed by the feeding unit; and
a thickness change detection unit detecting a change of the thickness of the record medium in the carrying direction based on a detection result of the thickness detection unit.

3. The image forming apparatus according to claim 1, including:
a type detection unit detecting a type of the record medium based on the change of the thickness of the record medium in the carrying direction.

4. The image forming apparatus according to claim 3, wherein
a type of the record medium is detected based on a single change of thickness.

5. The image forming apparatus according to claim 3, wherein
the type detection unit detects whether the type of the record medium is an envelope or not.

6. The image forming apparatus according to claim 5, wherein
when the type of the record medium is an envelope, an output indicating need for adjustment is made so as to adjust a distance between the recording head and the record medium.

7. The image forming apparatus according to claim 5, wherein
the distance between the recording head and the record medium is adjusted when the type of the record medium is an envelope.

8. The image forming apparatus according to claim 5, wherein
a printing mode is changed when the type of the record medium is an envelope.

9. The image forming apparatus according to claim 5, wherein
carrying of the record medium is stopped for a required time before the recording medium is fed to the image forming position when the type of the record medium is an envelope.

10. The image forming apparatus according to claim 9, wherein
a period of time when the carrying of the recording medium is stopped is capable of change.

11. The image forming apparatus according to claim 5, wherein
a printing start position relative to the record medium is changed when the type of the record medium is an envelope.

12. The image forming apparatus according to claim 11, wherein
a tip of the record medium is carried to a position of a regulation member for regulating a lift of the record medium.

13. The image forming apparatus according to claim 5, wherein
a carrying path for ejecting the record medium is set to be a paper ejection path determined in advance when the type of the record medium is an envelope.

14. The image forming apparatus according to claim 13, wherein
the paper ejection path for ejecting a record medium is set to be a horizontal paper ejection path for ejecting a record medium in a substantially horizontal manner.

15. The image forming apparatus according to claim 5, wherein
a status of a flap of the envelope is detected when the type of the record medium is an envelope.

16. The image forming apparatus according to claim 15, wherein
control for detecting a carrying error of the record medium is changed when the flap of the envelope is open.

17. The image forming apparatus according to claim 15, wherein
printing on the flap is regulated when the flap of the envelope is open.

18. The image forming apparatus according to claim 2, wherein
the thickness detection unit detecting the thickness of the record medium is disposed upstream relative to the image forming position and in a vicinity of a roller for carrying the record medium.

19. The image forming apparatus according to claim 18, wherein
the roller is a register roller.

20. A method for controlling an image forming apparatus, comprising the steps of:
discharging droplets of a recording liquid; and
forming the image on a record medium, wherein
control for an envelope is performed when a type of the record medium is determined as an envelope based on a change of a thickness of the record medium in a carrying direction.
